(19) United States
(12) Patent Application Publication
(10) Pub. No.: US 2010/0096516 A1
(43) Pub. Date: Apr. 22, 2010

(54) ROTATABLE MODULE

(75) Inventors: FAN ZHOU, Shenzhen City (CN); JIAN-ZHOU ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/466,371

(22) Filed: May 14, 2009

(30) Foreign Application Priority Data
Oct. 17, 2008 (CN) 200810304981.3

(51) Int. Cl. F16M 11/22

(52) U.S. Cl. 248/122.1

(57) ABSTRACT

A rotatable module includes a first connecting member, a second connecting member, and a pivotal shaft. The first connecting member is rotatably sleeved on the pivotal shaft. The second connecting member is non-rotatably sleeved on the pivotal shaft. One of the second connecting member or the first connecting member forms a resisting portion, and the other one of the second connecting member or the first connecting member forms at least one limiting portion. Both the resisting portion and the at least one limiting portion are substantially V-shaped protrusions. An extending direction of the resisting portion is substantially parallel to an extending direction of the limiting portion. The resisting portion resists the limiting portion such that the first connecting member rotates within a predetermined angle.

### BACKGROUND

1. Technical Field

The present disclosure relates to a rotatable module, particularly to a rotatable module employed in a flat display.

2. Description of the Related Art

Generally, a rotatable module is used to support a flat display such that the flat display is rotatable.

A typical rotatable module includes a first connecting member, a second connecting member, a restricting member positioned between the first and the second connecting member, and a pivotal shaft extending through the first connecting member, the restricting member, and the second connecting member, such that the second connecting member is rotatably sleeved on the pivotal shaft, and the restricting member and the first connecting member are non-rotatably sleeved on the pivotal shaft. The second connecting member is configured to attach to a flat display (not shown). A side surface of the second connecting member forms a stop protrusion. A periphery of the restricting member forms a first restricting portion and a second restricting portion.

In use, an external force is applied on the flat display to drive the flat display to rotate, thereby driving the second connecting member to rotate relative to the first connecting member. When the restricting protrusion resists the first restricting portion or the second restricting portion, the second connecting member stops rotating, thus the flat display is constrained between the first restricting portion and the second restricting portion.

However, since the restricting protrusion is typically a metal sheet and has a weak strength, when it rotates to the first restricting portion or the second restricting portion, it strikes either the first restricting portion or the second restricting portion, thereby abrading and damaging the restricting protrusion. After many cycles, the strength of the restricting protrusion is reduced because of the abrasion.

Therefore, a rotatable module to solve the aforementioned problems is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of an embodiment of a rotatable module.

FIG. 2 is an exploded, isometric view of the rotatable module of FIG. 1.

FIG. 3 is similar to FIG. 2, but shown from another aspect.

### DETAILED DESCRIPTION

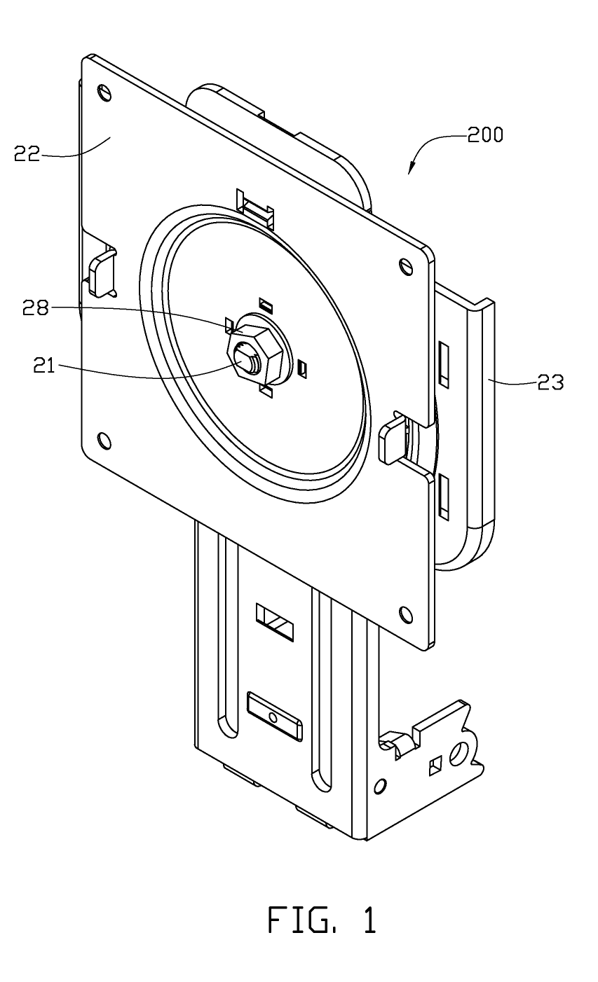

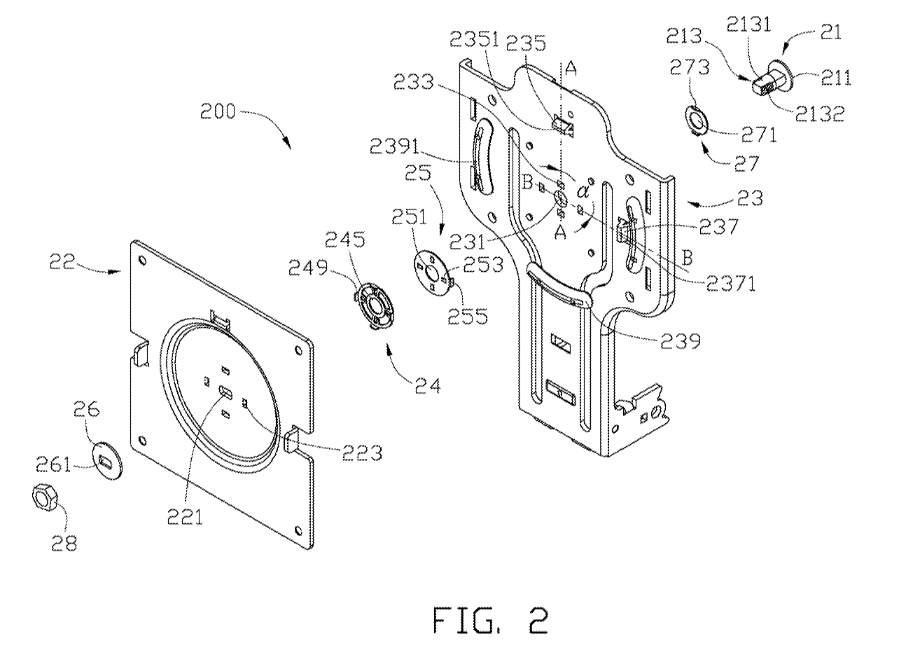

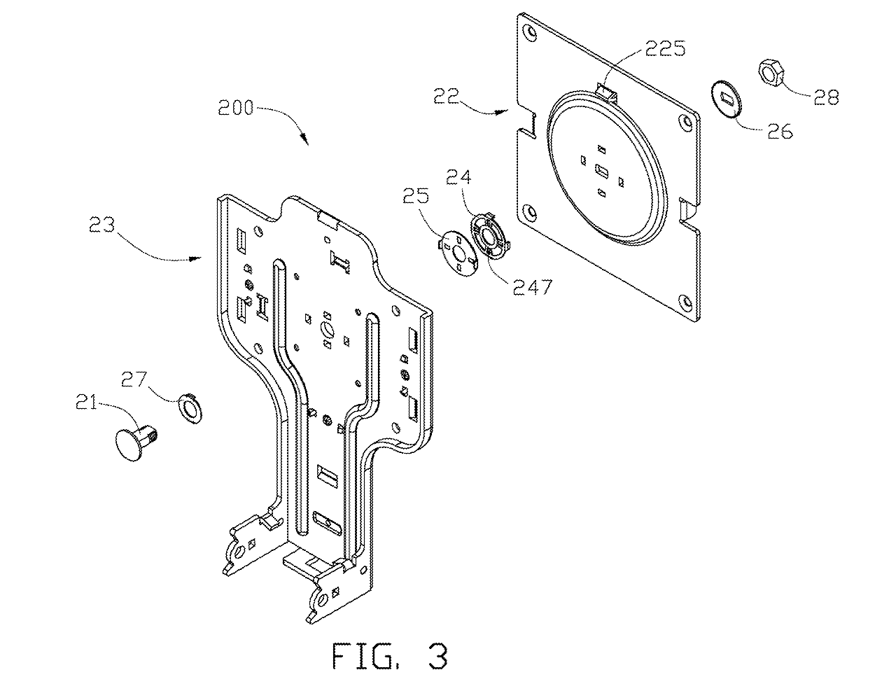

Referring to FIGS. 1 through 3, the rotatable module 200 may be employed in a display device such as a liquid crystal display. The rotatable module 200 includes a pivotal shaft 21, a first connecting member 22, a second connecting member 23, a first washer 24, a second washer 25, an elastic member 26, a frictional member 27, and a fixing member 28. The first connecting member 22 is configured to attach to a flat display (not shown). The second connecting member 23 is fixed on a supporting frame (not shown). The fixing member 28 may be a screw nut.

The pivotal shaft 21 includes a flange 211 and a shaft portion 213 extending from the flange 211. The shaft portion 213 is substantially cylindrical and has a flat surface 2131 along a section thereof. In the illustrated embodiment, the shaft portion 213 has two flat surfaces 2131 on opposite sides of the shaft portion 213. A plurality of screw threads 2132 is defined in an end of the shaft portion 213 away from the flange 211.

The first connecting member 22 may be a substantially flat sheet. The first connecting member 22 defines a deformed hole 221 to receive the pivotal shaft 21, and a plurality of fixing holes 223 adjacent to the deformed hole 221.

A resisting portion 225 is formed on a surface of the first connecting member 22. The resisting portion 225 may be a substantially V-shaped protrusion formed by stamping or injection molding.

The second connecting member 23 may be a plate. The second connecting member 23 defines a substantially circular connecting member hole 231 in a center portion of the second connecting member 23 and a plurality of fixing holes 233 adjacent to the connecting member hole 231.

A first limiting portion 235 and a second limiting portion 237 are formed on a surface of the second connecting member 23. The first limiting portion 235 and the second limiting portion 237 may be substantially V-shaped protrusions. A first line A-A from a center portion 2351 of the first limiting portion 235 to a center of the connecting member hole 231, and a second line B-B from a center portion 2371 of the second limiting portion 237 to a center of the connecting member hole 231 form an angle α. In the illustrated embodiment, the angle α is about 90 degrees. The first limiting portion 235 and the second limiting portion 237 may be formed by stamping or injection molding. Three protruding ledges 239 may be formed on the second connecting member 23 adjacent to a periphery of the second connecting member 23. Each protruding ledge 239 may be substantially curved such that the center of curvature of each protruding ledge 239 is substantially aligned with a center of the connecting member hole 231.

The first washer 24 may be substantially circular. The first washer 24 defines a substantially circular pivotal hole 245 and four position grooves 247 adjacent to the pivotal hole 245. A plurality of latching tabs 249 configured to engage with the fixing holes 223 of the first connecting member 22 are formed on a periphery of the first washer 24.

The second washer 25 may be substantially circular. The second washer 25 defines a substantially circular through hole 251 in a center portion of the second washer 25 and forms a plurality of position protrusions 253 adjacent to the through hole 251. The position protrusions 253 are configured to engage with the position grooves 247 of the first washer 24. In addition, a periphery of the second washer 25 forms two latching pieces 255.

The elastic member 26 defines a deformed hole 261 corresponding to the pivotal shaft 21 in a center portion of the elastic member 26.

The frictional member 27 may be substantially circular. The frictional member 27 defines a substantially circular through hole 271 in a center portion of the frictional member 27 and forms two opposite latching tabs 273 on a periphery of the frictional member 27.

When assembling the rotatable module 200, the latching tabs 249 of the first washer 24 are inserted into the fixing holes 223 of the first connecting member 22 such that the first washer 24 is fixed on the first connecting member 22, and the center portion of the pivotal hole 245 is substantially aligned with the center of the deformed hole 221.

The two latching pieces 255 of the second washer 25 are inserted into two of the fixing holes 233 of the second connecting member 23, and the two latching pieces 273 of the frictional member 27 are inserted into another two of the fixing holes 233 of the second connecting member 23 such that the frictional member 27 is fixed on a surface away from the first limiting portion 235 of the second connecting member 23. The center of the through hole 271 of the frictional member 27, the center of the through hole 251 of the second washer 25, and the center of the connecting member hole 231 of the second connecting member 23 are substantially collinear, and the resisting portion 225 is between the first limiting portion 235 and the second limiting portion 237.

The shaft portion 213 is passed through the through hole 271 of the frictional member 27, the connecting member hole 231 of the second connecting member 23, the through hole 251 of the second washer 25, the pivotal hole 245 of the first washer 24, the deformed hole 221 of the first connecting member 22, and the deformed hole 261 of the elastic member 26. The screw threads 2132 of the shaft portion 213 are engaged with the fixing member 28 such that the second connecting member 23 is adjacent to the first connecting member 22, the resisting portion 225 is substantially parallel to an extending direction of the first limiting portion 235 and the second limiting portion 237, and the position protrusions 253 are latched in the position grooves 247.

The protruding ledges 239 resist the first connecting member 22 to prevent the side surface of the second connecting member 23 from resisting the first connecting member 22 directly.

The flat display may be fixed on the first connecting member 22. In one state, the resisting portion 225 is on a side of the first limiting portion 235 and the position protrusions 253 are received in the position grooves 247. As a result, the flat display can be stably held in a first position relative to a table.

To change the flat display to another state, an external force is applied to rotate the flat display. Since the first connecting member 22 and the elastic member 26 are non-rotatably sleeved on the pivotal shaft 21, the first connecting member 22, the elastic member 26, and the pivotal shaft 21 will rotate together with the flat display. The position protrusions 253 slide out of the position grooves 247 of the first washer 24, so that the flat display can rotate stably due to a frictional force between the flange 211 of the pivotal shaft 21 and the frictional member 27.

After the flat display rotates, for example, about 90 degrees, the resisting portion 225 resists the second limiting portion 237 such that the flat display is unable to rotate any further. The position protrusions 253 also become latched in the position grooves 247 again.

It should be pointed out that since each protruding ledge 239 is substantially curved, and the center of curvature of each protruding ledge 239 is substantially aligned with a center of the connecting member hole 231, the center of curvature of each protruding ledge 239 should substantially align with a central axis of the pivotal shaft 21. As a result, the first connecting member 22 is able to rotate relative to the second connecting member 23. In addition, a protruding surface 2391 of each protruding ledge 239 is rounded to form a convex structure to increase a frictional area between the first connecting member 22 and the second connecting member 23, so that the first connecting member 22 is able to rotate relative to the second connecting member 23 stably.

It may be understood that a frictional force between the flange 211 and a surface of the frictional member 27, and the axis force, which drives the position protrusions 253 to engage in the position grooves 247, may be adjusted by rotating the fixing member 28 about the screw threads 2132 of the shaft portion 213.

The resisting portion 225, the first limiting portion 235 and the second limiting portion 237 have a higher mechanical strength than a conventional limiting member made of a thin metal sheet because the resisting portion 225, the first limiting portion 235, and the second limiting portion 237 are formed on a surface of the corresponding member by stamping or injection molding.

It should also be pointed out that a rotatable angle range that the flat display can rotate can be configured by changing a position of the first limiting portion 235 relative to the second limiting portion 237, thus changing the angle α. For example, an angle α of about 60 degrees would further limit the range of rotation.

It may be understood that the resisting portion 225 may be formed on the second connecting member 23, and the first limiting portion 235 and the second limiting portion 237 are formed on the first connecting member 22.

The fixing member 28 may also be a rivet nut. In addition, if the first washer 24 and the second washer 25 are omitted, the flat display would still be able to remain in a desired position due to a friction force between the first connecting member 22 and the protruding ledges 239 of the second connecting member 23.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A rotatable module comprising:
a pivotal shaft,
a first connecting member rotatably sleeved on the pivotal shaft, and
a second connecting member non-rotatably sleeved on the pivotal shaft, wherein a resisting portion is formed on one of the second connecting member or the first connecting member, and at least one limiting portion is formed on the other one of the second connecting member or the first connecting member; both the resisting portion and the at least one limiting portion are substantially V-shaped protrusions; an extending direction of the resisting portion is substantially parallel to an extending direction of the limiting portion; the resisting portion resists the at least one limiting portion such that the first connecting member rotates within a predetermined angle.

2. The rotatable module as claimed in claim 1, wherein the at least one limiting portion comprises a first limiting portion and a second limiting portion; the first limiting portion and the second limiting portion are formed on the second connecting member; the resisting portion is formed on the first connecting member; the resisting portion is positioned between the first limiting portion and the second limiting portion, such that the resisting portion resists the first limiting portion or the second limiting portion, when the first connecting member rotates a predetermined angle.

3. The rotatable module as claimed in claim 2, wherein the predetermined angle is about 90 degrees.

4. The rotatable module as claimed in claim 1, further comprising a first washer and a second washer, wherein a surface of the second washer forms a plurality of position protrusions, and the first washer defines a plurality of position grooves to engage with the position protrusions; the first washer is fixed on the first connecting member and the second washer is fixed on the second connecting member.

5. The rotatable module as claimed in claim 4, wherein the first connecting member defines a plurality of fixing holes; a periphery of the first washer forms a plurality of latching tabs engaging with the fixing holes of the first connecting member.

6. The rotatable module as claimed in claim 4, wherein the second connecting member defines a fixing hole, a periphery of the second washer forms a latching piece to be latched in the fixing hole of the second connecting member.

7. The rotatable module as claimed in claim 1, further comprising a fixing member, wherein the pivotal shaft comprises a flange and a shaft portion extending from a side of the flange; the fixing member is fixed on an end of the pivotal shaft, away from the flange.

8. The rotatable module as claimed in claim 7, wherein the fixing member is a screw nut; the pivotal shaft forms a plurality of threads to engage with the screw nut.

9. The rotatable module as claimed in claim 1, wherein three curved protruding ledges are formed adjacent to a periphery of the second connecting member, and the protruding ledges resist the first connecting member.

10. The rotatable module as claimed in claim 9, wherein each protruding ledge is substantially curved, and a center of curvature of each protruding ledge is substantially aligned with a central axis of the pivotal shaft.

11. The rotatable module as claimed in claim 10, wherein a top end of each protruding ledge is rounded.
